(19) United States
(12) Patent Application Publication
(10) Pub. No.: US 2013/0290439 A1
(43) Pub. Date: Oct. 31, 2013

(54) Method and apparatus for notification and posting at social networks

(71) Applicant: Jan Otto Blom, Lutry (CH)

(72) Inventor: Jan Otto Blom, Lutry (CH)

(73) Assignee: Nokia Corporation, Espoo (FI)

(21) Appl. No.: 13/458,379

(22) Filed: Apr. 27, 2012

(51) Int. Cl. G06F 15/16

(52) U.S. Cl. 709/206

(57) ABSTRACT

An approach is provided for processing of one or more communication messages to determine one or more contexts. Further, a comparison is made of contextual information associated with one or more potential posting users against the one or more contexts. Furthermore, one or more posting alerts are presented to the one or more potential posting users based, at least in part, on the comparison.

### BACKGROUND

Service providers (e.g., wireless, cellular, etc.) and device manufacturers are continually challenged to deliver value and convenience to consumers by, for example, providing compelling network services. One area of interest has been the development of social networking services for building connections and forming social networks among groups of users for receiving and providing contents/updates (e.g., online blog posts) associated with a user, a topic, an event at a geo-location, and the like. As popularity of such services and potential topics of interest for a user increase, the users may find it more difficult or burdensome to seek posts about an event and/or provide updates/postings about an event. As a result, service providers and device manufacturers face significant technical challenges to facilitating discovery and presentation of potential social network events/postings to interested users as well as provide opportunities for the users to submit their own postings about the events.

### Some Example Embodiments

Therefore, there is a need for an approach to identify and process one or more communication messages/postings (e.g., social networking postings) and alert potential posting users for submitting additional postings.

According to one embodiment, a method comprises processing and/or facilitating a processing of one or more communication messages to determine one or more contexts. The method also comprises causing, at least in part, a comparison of contextual information associated with one or more potential posting users against the one or more contexts. The method additionally comprises causing, at least in part, a presentation of one or more posting alerts to the one or more potential posting users based, at least in part, on the comparison.

According to one embodiment, an apparatus comprising at least one processor; and at least one memory including computer program code for one or more programs, the at least one memory and the computer program code configured to, with the at least one processor, cause the apparatus to process and/or facilitate a processing of one or more communication messages to determine one or more contexts. The apparatus is also caused to cause, at least in part, a comparison of contextual information associated with one or more potential posting users against the one or more contexts. The apparatus is further caused to cause, at least in part, a presentation of one or more posting alerts to the one or more potential posting users based, at least in part, on the comparison.

According to another embodiment, a computer-readable storage medium carrying one or more sequences of one or more instructions which, when executed by one or more processors, cause, at least in part, an apparatus to process and/or facilitate a processing of one or more communication messages to determine one or more contexts. The apparatus is also caused to cause, at least in part, a comparison of contextual information associated with one or more potential posting users against the one or more contexts. The apparatus is further caused to cause, at least in part, a presentation of one or more posting alerts to the one or more potential posting users based, at least in part, on the comparison.

According to another embodiment, an apparatus comprises means for processing and/or facilitating a processing of one or more communication messages to determine one or more contexts. The apparatus also comprises means for causing, at least in part, a comparison of contextual information associated with one or more potential posting users against the one or more contexts. The apparatus additionally comprises means for causing, at least in part, a presentation of one or more posting alerts to the one or more potential posting users based, at least in part, on the comparison.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of identifying and processing one or more communication messages and alerting potential posting users for submitting additional postings, according to one embodiment;

FIG. 2 is a diagram of components of a processing platform, according to one embodiment;

FIG. 3 is a diagram of components of a user equipment, according to one embodiment;

FIGS. 4 and 5 are flowcharts of processes for identifying and processing communication messages and presenting posting alerts, according to various embodiments;

FIG. 6 illustrates contextual information and content determined from one or more communication messages, according to one embodiment;

FIG. 7 illustrates a textual communication message by a user associated with an a events at a geo-location, according to one embodiment;

FIG. 8 illustrates graphical contents indicating points of interest associated with one or more communication messages, according to one embodiment;

FIG. 9 illustrates presentation of location information of one or more communication messages on a map application, according to one embodiment;

FIG. 10 is a diagram of hardware that can be used to implement an embodiment of the invention;

FIG. 11 is a diagram of a chip set that can be used to implement an embodiment of the invention; and

FIG. 12 is a diagram of a mobile terminal (e.g., handset) that can be used to implement an embodiment of the invention.

### DESCRIPTION OF SOME EMBODIMENTS

Examples of a method, apparatus, and computer program for identifying and processing one or more communication messages (e.g., social networking postings) and alerting potential posting users for submitting additional postings. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

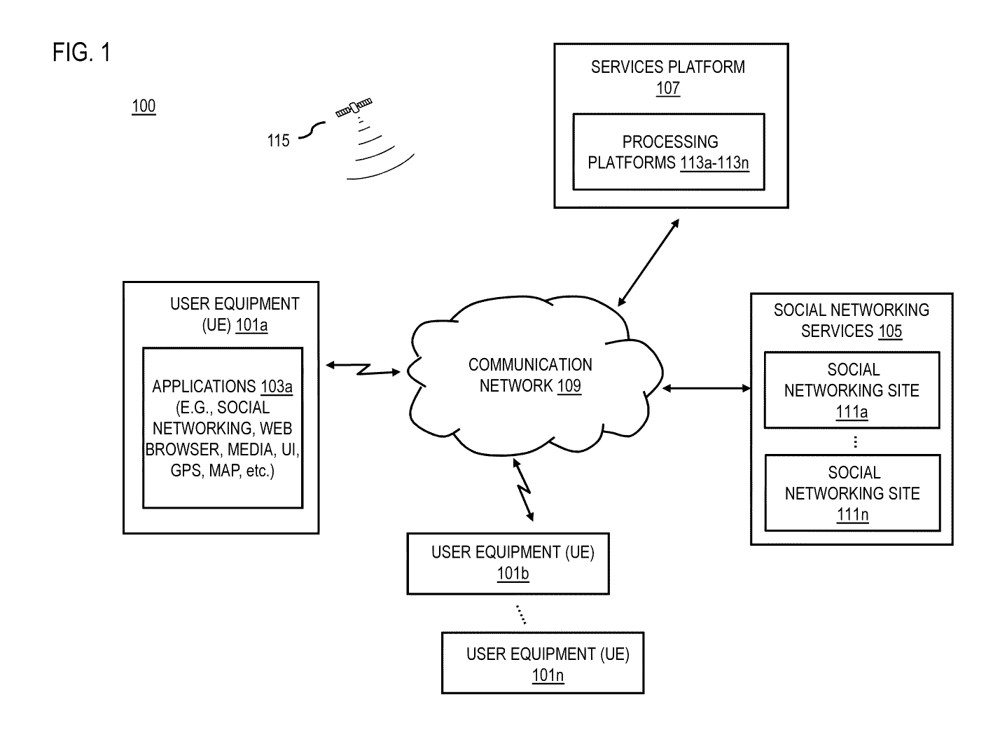

FIG. 1 is a diagram of a system for processing social networking information and notifying potential posting-users, according to one embodiment. Traditionally, users of social networking services share information about various topics of interest (e.g., blogging) and/or about an event at a geo-location (e.g., a real event), which the users may be participating in, witnessing, or may be able to provide related comment/content. For instance, events such as concerts, demonstrations, conferences, public speeches, disasters, and the like may prompt a user or a group of users located in the proximity of the events to post comments, contents (e.g., pictures, video, audio, etc.), information, and the like pertaining to the events, where such posts may have significant impacts on social networking activities (e.g., blogs). For example, a picture of a demonstration posted at and/or via various social networking services (e.g., Facebook®, Twitter®, personal blogs, etc.) could be viewed and commented on by hundreds of thousands of individuals. Generally, these social networking services are also responsible for mediation of social networking activities, such as geographically triggered online social interactions among users, wherein it may be in the interest of the users, the social networking service providers, and/or people involved in the events to attract as many audience and user reactions as possible (e.g., a higher traffic). For example a service provider may detect the events, notify the users, and present options/opportunities for the users to submit additional comments, information, content, and the like for a more comprehensive, inclusive, and interesting user experience. Further, it also may be advantageous to determine a trend of online activities; for example, users posting about an impromptu unscheduled on-campus student rally, which will take place in 30 minutes; and send notifications to other users close to the campus location so that the other users would have opportunities to submit early postings and attract followers (e.g., other users) on their postings.

However, with the traditional approach, there often is a lag/delay for users to discover trends in online postings (e.g., social networking activities) and/or postings about a real event (e.g., a concert, a public speaking, a rally, etc.), which may be in close proximity to the users' location and/or may be associated with a geo-location that is of interest to the users. As such there is a need for capabilities to detect and analyze social networking information (e.g., posted by users and/or service providers) for determining context (e.g., associated with a user, event, posting, blog, trend, etc.), to identify and notify potential posting-users and/or interested online users, and to present opportunities for the users to submit additional postings about the social networking information.

To address this problem, a system 100 of FIG. 1 introduces the capability to process one or more communication messages (e.g., social networking information), determine context associated with the one or more communication messages, and notify potential online posting-users. In other words, the system 100 (e.g., a service provider) analyzes geo-locations of service users who are posting content (e.g., text, audio, pictures, video, etc.) to online communication platforms such as micro blogs and social networking sites (Facebook®, Twitter®, etc.), in order to identify “posting hot spots” (e.g., areas associated with multiple service users posting content within a narrow period of time.) Further, the system 100 causes an analysis of the content to determine contextual information such as geographic reference points (e.g., points of interest, POIs), real physical activities/events, user ID, and the like associated with the posted content from the posting hot spots. In one example, the analysis can determine and/or link postings that include similar references to events/activities associated with a same POI and/or geo-location (e.g., from users at a posting hot spot). For example, content included in one or more communication messages posted from a posting hot spot is analyzed to determine geo-location/geographic POIs, wherein the POIs may include buildings, parks, town squares, and the like in vicinity of the user posting/sending the communication message. Further, POIs may include geo-located activities taking place in close proximity to the user (e.g. riot, speech, street party, concert, etc.), wherein a geo-located activity may be utilized as a reference point and a trigger for indicating hot spots.

In various embodiments, different techniques may be utilized to extract geo-location reference points from the communication messages. In one embodiment, the geo-location information of a user posting a communication message is determined by GPS information associated with a user device. Further, POIs near the geo-location may be determined from a service provider database, for example, to identify buildings and other geo-located objects/landmarks located near the user's geo-location. For instance, the analysis may determine POIs such as a harbor, a park, and buildings “X,” “Y,” and “Z” are located near the user posting from a hot spot.

In another embodiment, for textual communication messages (e.g., SMS, text comments) one or more text strings may be analyzed to determine POIs (e.g. “Big Ben Bar,” “City Square,” “City College,” etc.) as well as geo-located activities (e.g. word “riot,” “speech,” “party,” etc.).

In another embodiment, multimedia content included in a communication message may be analyzed by one or more image recognition processes to recognize geo-located reference points featuring one or more images included in the multimedia content. For example, when geo-located objects/landmarks (e.g., buildings, parks, statues, etc.) are recognized, they are compared against one or more POI databases in order to determine the actual object/landmark. For instance, if an image recognition process results in identification of an apartment building (e.g., determined to be situated north-west of the posting user's present location) then the actual apartment building is identified using the POI database. In addition to geo-located objects, the image recognition process may also indicate geo-located activities such as a social behavior (e.g., presence of a crowd of people).

Additionally, the system 100 can determine, categorize, and/or indicate popularity information (e.g., ratings, rankings, comments, etc.) associated with the context, wherein the popularity information may be provided, at least in part, by users, social networking services, other service providers, and the like. For example, the popularity information of a posting may include access/view frequency by other users, reaction of the other users to the posting (e.g. on Facebook®, how many people “like/dislike” a given posting), number of web-links associated with the post, and the like. Moreover, the system 100 can categorize the posting hot spots having high levels of popularity as “posting opportunity areas” and based on one or more threshold values, present one or more posting alerts to users who are associated with the geo-location (e.g., currently at/close to the geo-location, remote user interested in the geo-location, etc.) and who currently may not be posting content online. In one example, a posting alert (e.g., delivered via a mobile communication network) includes references to a frequently occurring geographic POI and associated available information so that associated users (e.g., currently at/close to the geo-location/POI, remote user interested in the geo-location/POI, etc.) may easily recognize the posting opportunity and/or find the posting opportunity area. In this way, the system 100 enables analysis of communication messages (e.g., social networking information, blogs, chats, etc.) from and/or among users, determination of one or more potential posting opportunities (e.g., hot spots, near an event, on a topic, etc.), and present posting alerts to one or more potential posting users. Further, the system 100 may also be capable of suggesting that a social network be created (e.g., temporarily or permanently) for the group of users associated with and posting about a posting hot spot.

In various embodiments, posts/communication messages sent from a posting hot spot may have different impacts on users, wherein the impacts may be determined by the number of users accessing the posts, the number of comments created by the users viewing the posts, strength/level of reaction of the users to the posts (e.g., on a social networking site, how many people “like/dislike” a given post), the number of links created to the posts, and the like. Further, the analysis may differentiate between low and high impact posting hot spots. For instance, several users may be updating their Facebook® status to reflect a usual traffic jam they are stuck in. However, such posts may not have a strong social impact in a sense that general population of Facebook® users is less likely to follow and reflect on such posts. However, in one example, thousands of Facebook® users may be accessing content posted by users who are participating in a very popular musical concert (e.g., by a super star). Considering the two traffic jam scenarios, the posts associated with the usual traffic jam suggesting a posting hot spot may be categorized by the system 100 as non-popular, wherein hot spot suggested by the traffic jam associated with the popular musical concert may be categorized as very popular.

In one embodiment the system 100 causes a processing of one or more communication messages to determine one or more contexts. In one embodiment, a service provider (e.g., Nokia® Services) searches for and compiles one or more communication messages between one or more users and one or more services platforms (e.g., Facebook®, social networking sites, private and public blogging sites, etc.) and processes/analyzes the communication messages to determine associated context and contextual information (e.g., social networking information). For example, a communication message (e.g., a posting to a social networking site) from a user is sent to a social networking service provider, wherein the message includes contextual information about a topic, an event, a geo-location, and the like. In one embodiment, the service provider utilizes one or more algorithms, applications, software, and the like (e.g. web crawlers) to search for and analyze the one or more communication messages. In another embodiment, the one or more services platforms (e.g., Facebook®) utilize one or more algorithms, applications, software, and the like, to search for the communication messages at the one or more services platform (e.g., Facebook®) and further perform the analysis. In one embodiment, one or more service providers (e.g., Nokia®) and one or more services platforms (e.g., Facebook®) establish one or more mechanisms/agreements for conducting the search and analysis of the communication messages.

In one embodiment the system 100 causes a comparison of contextual information associated with one or more potential posting users against the one or more contexts. In one example, contextual information includes information about content of the communication message such as a topic, content type (e.g., text, video, audio, etc.), geo-location of a POI, geo-location of one or more users associated with the communication message, an event, and the like. In one use case scenario, the system 100 compares the contextual information with one or more potential users to determine users who may be interested in providing/posting additional communication messages, social networking information, and the like. In one embodiment, determination of potential users are based, at least in part, on a user's geo-location, a user profile (e.g., age, gender, etc.), user preferences indicating interest in certain topics, content types, event types, certain geo-locations, POIs, and the like, wherein the user profile and/or the user preferences may be stored at one or more user devices, at one or more social networking services, at one or more services platforms, and/or at one or more other service providers.

In one embodiment the system 100 causes a presentation of one or more posting alerts to the one or more potential posting users based, at least in part, on the comparison. In one embodiment, a service provider determines a potential posting user based on one or more matches identified in the comparison and presents one or more posting alerts to the potential user. For example, a posting alert is presented to a user who is in close proximity to an event (e.g., a rock concert) and/or the user preferences indicate that the user would be interested in posting about the event. In one embodiment the one or more users associated with the one or more communication messages and/or the one or more potential posting users are either at the geo-location, in a close proximity to the geo-location, at a remote geo-location, or will arrive at the geo-location in the near future. For example, a user (e.g., a posting user) may send a communication message to a social networking site about an event at a certain geo-location, wherein the user currently is at a different geo-location (e.g., remote) than the event geo-location. In another example, a potential posting user is at a remote location with reference to a potential posting alert associated with a certain geo-location.

In one embodiment the system 100 determines popularity information associated with the one or more contexts. In one example, the popularity information indicates frequency of access and/or referral to the one or more contexts of the communication messages (e.g., postings). For example, a context may be referred to in multiple communication messages (e.g., postings), by multiple users, and/or at multiple service platforms (e.g., social networking sites).

In one embodiment the system 100 causes an initiation of the presentation of the one or more posting alerts based, at least in part, one or more threshold values associated with the popularity information. In one use case scenario, the popularity information can trigger the presentation of the one or more posting alerts to one or more users. For example, popularity information associated with a certain context may match a threshold value set in a user profile and/or preference, which can cause the presentation of the posting alert. In one embodiment, the one or more threshold values are based, at least in part, on one or more parameters associated with the one or more contexts, one or more user preferences, a ranking, a rating, a category, a content type, a geo-location, a topic, identity of a posting user, time of the posting, or a combination thereof.

In one embodiment the presentation of the one or more posting alerts is via a map application, a texting application, a multimedia application, or a combination thereof. In one example, the posting alert is presented as a list including one or more items providing one or more information items (e.g., geo-location, context, event information, posted content types, suggested content types to post, etc.) associated with one or more posting opportunities. In another example, the posting alerts are presented on a map application, whereby a user may utilize a user interface to interact with the map application indicating the user location and/or location of the potential posting alerts (e.g., events) presented thereon. It is noted that the user interface 311 provides a means of interaction between the users and the various executions and features of one or more processing platforms and one or more social networking services by way of a keyboard, virtual keypad, stylus, or other data input mechanism. Any capabilities afforded by a particular social networking services may be rendered to the display of a user device by way of a user interface.

In one embodiment the system 100 determines one or more content types associated with the one or more communication messages. In one example, the one or more communication messages may include one or more contents of different types such as textual, audio, video, photos, and the like. In various embodiments, the system 100 may utilize one or more applications and/or algorithms to determine the content type, where the content types are not explicitly indicated.

In one embodiment the system 100 causes a presentation of a suggestion for one or more content types to the one or more potential posting users based, at least in part, on the determined one or more content types. In one embodiment, based on the determined content types associated with the one or more communication messages, the system 100 may further determine one or more over-represented and/or under-represented content types (e.g., textual, multimedia, etc.) and accordingly provide one or more suggestions to the potential posting users as to what content types to include with their postings. For example, a musical concert may trigger many users to take pictures of the concert stage and upload/share them via one or more social networking sites (e.g., Facebook®, Twitter®, etc.). However, online audience remotely following the concert through the social networking posts may be particularly interested in additional textual posts as it could provide additional perspectives and points for people to follow and potentially provide additional input/comments.

In one embodiment the system 100 determines geo-location information associated with the one or more contexts, one or more users associated with the one or more communication messages, the one or more potential posting users, or a combination thereof. In various embodiments, the system 100 may utilize information, metadata, content, and the like associated with the one or more contexts to determine a geo-location associated with the context and/or a user providing a communication message. For example, the system 100 may utilize a photo (e.g., Eifel Tower) included in a communication message to determine a substantially accurate geo-location (e.g., Paris). In another example, a geo-location may be determined by GPS location information associated with a user device, metadata associated with a multimedia item, and the like. In another embodiment, a user may manually enter/provide/submit a geo-location of the user and/or of an event via a user device.

In one embodiment the system 100 determines one or more possible future events based, at least in part, on the one or more communication messages. In one embodiment, system 100 analyzes contextual information included in metadata of a communication message (e.g., uploaded posts) and/or multimedia content items associated with a posting opportunity areas in order to determine contextual factors which may assist in predicting emergence of early signs of potential posting opportunity areas (e.g., hot spots). For example, in a case of a musical concert in a given stadium, the analysis may indicate/suggest that a musical concert typically is preceded by increased traffic around the stadium. Hence in the future, upon detecting such early signs of emergence of posting opportunity hot spots, users may be provided with tips about the onset of such events in the near future.

In one embodiment the system 100 causes a presentation of the one or more posting alerts to the one or more potential posting users based, at least in part, on the one or more possible future events. In one example, upon detecting early signs of a potential posting opportunity area, the system 100 may present posting alerts to potential users about possible events in the near future, wherein the early posting alerts may be useful for users who wish to be the first ones to start posting about an interesting event, topic, and the like and to quickly gather followers (e.g., other users, service providers, bloggers, etc.)

In one embodiment the one or more communication messages are among multiple users wherein the system 100 determines one or more non-social networking related contexts. In one example, multiple users may exchange one or more communication messages (e.g., including social networking information) with each other via a communication network (e.g., cellular network, WLAN, etc.) before and/or without posting the messages to a social networking site/service, wherein the system 100 may analyze these communication messages in order to determine possible contextual information associated with a potential posting opportunity (e.g., an event, a geo-location, a topic, etc.) In one embodiment the system 100 determines one or more other posting alerts based, at least in part, on the one or more non-social networking contexts and facilitates a sharing of the one or more other posting alerts among the multiple users. For example, the system 100 determines one or more other posting alerts based on the non-social networking context and facilitates sharing of the one or more other posting alerts among the multiple users and/or with one or more social networking sites.

In one embodiment the system 100 determines the one or more contexts based, at least in part, on content information associated with the one or more communication messages.

In one embodiment, textual content of the communication messages (e.g., SMS, text comments) and/or one or more text strings may be analyzed to determine POIs (e.g. “Big Ben Bar,” “City Square,” “City College,” etc.) as well as geo-located activities (e.g. word “riot,” “speech,” “party,” etc.). In another embodiment, multimedia content included in the communication message may be analyzed by one or more image recognition processes to recognize geo-located reference points featuring one or more images included in the multimedia content. For example, when geo-located objects/landmarks (e.g., buildings, parks, statues, etc.) are recognized, they are compared against one or more POI databases in order to determine the actual object/landmark. For instance, if an image recognition process results in identification of an apartment building (e.g., determined to be situated north-west of the posting user's present location) then the actual apartment building is identified using the POI database. In addition to geo-located objects, the image recognition process may also indicate geo-located activities such as a social behavior (e.g., presence of a crowd of people).

As shown in FIG. 1, in one embodiment, the system 100 comprises user equipment (UEs) 101a-101n (also collectively referred to as UE 101) which may be utilized to execute one or more applications 103a-103n (also collectively referred to as applications 103) (e.g., a social networking application, a web browser, a media application, user interface, GPS, a mapping application, a web client, etc.) to communicate with other UE 101, social networking services 105, services platform 107, and/or with other components (e.g., a GPS satellite) of a communication network directly and/or over a communication network 109. In one embodiment, the social networking services 105 may include one or more social networking sites 111a-111n (also collectively referred to as SNS 111) which may provide access to one or more online social networking platforms and/or services (e.g., Facebook®, Twitter®, personal blog, chat, etc.). In one embodiment, the services platform 107 may include one or more processing platforms 113a-113n (also collectively referred to as processing platform 113), which may provide one or more services to the UE 101, the social networking services 105, and/or the SNS 111.

In one embodiment, the services platform 107 may include one or more service providers offering one or more services, for example, social networking services (e.g., blogging), online shopping, banking, media upload, media download, media streaming, account management services, or a combination thereof. Further, the services platform 107 may conduct a search for social networking information (e.g., associated with one or more online and/or real physical events) at the services platform 107, the UE 101, the social networking services 105 or the like and cause a processing of the social networking information via the processing platform 113. In certain embodiments, the processing platform 113 is implemented as a collection of one or more hardware, software, algorithms, firmware, or combinations thereof that can be integrated for use with the services platform 107 and/or with the social networking services 105. In various embodiments, the processing platform 113 can be maintained on a network server, while operating in connection with the services platform 107 and/or with the social networking services 105 as an extensible feature, a web-service, an applet, a script, an object-oriented application, or the like to enable searching for and/or processing of the social networking information. Further, the processing platform 113, the social networking services 105 and/or the services platform 107 may utilize one or more service application programming interfaces (APIs)/integrated interface, through which communication messages (e.g., social networking information) may be shared, accessed and/or processed.

In one embodiment, the processing platform 113, services platform 107 and/or the social networking services 105 interact according to a client-server model. It is noted that the client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

By way of example, the communication network 109 of the system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, processing platform 113, services platform 107 and/or the social networking services 105 communicate with each other and other components of the communication network 109 using well known, new or still developing protocols. In this context, a protocol includes a set of rules defining how the network nodes within the communication network 109 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

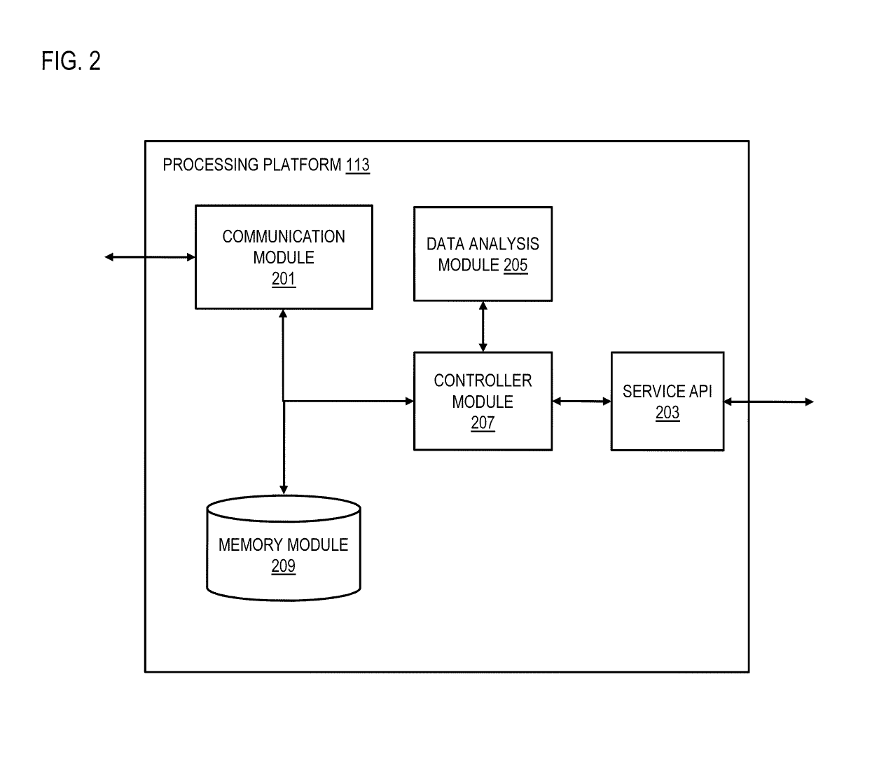

FIG. 2 is a diagram of the components of processing platform 113, according to an embodiment. By way of example, the processing platform 113 includes one or more components capable of searching for and/or processing one or more communication messages (e.g., social networking information) from the UE 101, the social networking services 105, the services platform 107, and/or from other components of the communication network 109. It is contemplated that the functions of these components may be combined in one or more components or performed by other components of equivalent functionality. In this embodiment, the processing platform 113 includes a communication module 201, a service API 203, a data analysis module 205, a controller module 207 that can execute processes (e.g., associated with one or more algorithms, software, applications, etc.), and a memory module 209.

In one embodiment, the processing platform 113 includes a communication module 201. The communication module 201 can be used to communicate with UE 101, the social networking services 105, the services platform 107, and/or other components of the communication network 109. The processing platform 113 can receive communication messages (e.g., including social networking information) from the UE 101 via the communication module 201 via methods such as internet protocol, MMS, SMS, GPRS, or any other available communication method. Further, the controller module 207 may utilize the communication module 201 to provide social networking information (e.g., associated with online events, real physical events, posting by other users, posting opportunities, posting hot spots, etc.) to the UE 101, the social networking services 105, the services platform 107, and/or to other components of the communication network 109. Further, the controller module 207 may utilize the service API 203 (e.g., in conjunction with the communication module 201) to interact with the social networking services 105, the services platform 107, and/or other components of the communication network 109.

The data analysis module 205 in conjunction with the controller module 207 may utilize one or more applications, algorithms, software, and the like, to perform one or more analysis, comparisons, evaluations, and/or other functions on one or more communication messages received from the UE 101, the social networking services 105, the services platform 107, and/or other components of the communication network 109 in order to ascertain the social the social networking information associated with one or more online events, real physical events, posting by other users, posting opportunities, posting hot spots, and the like.

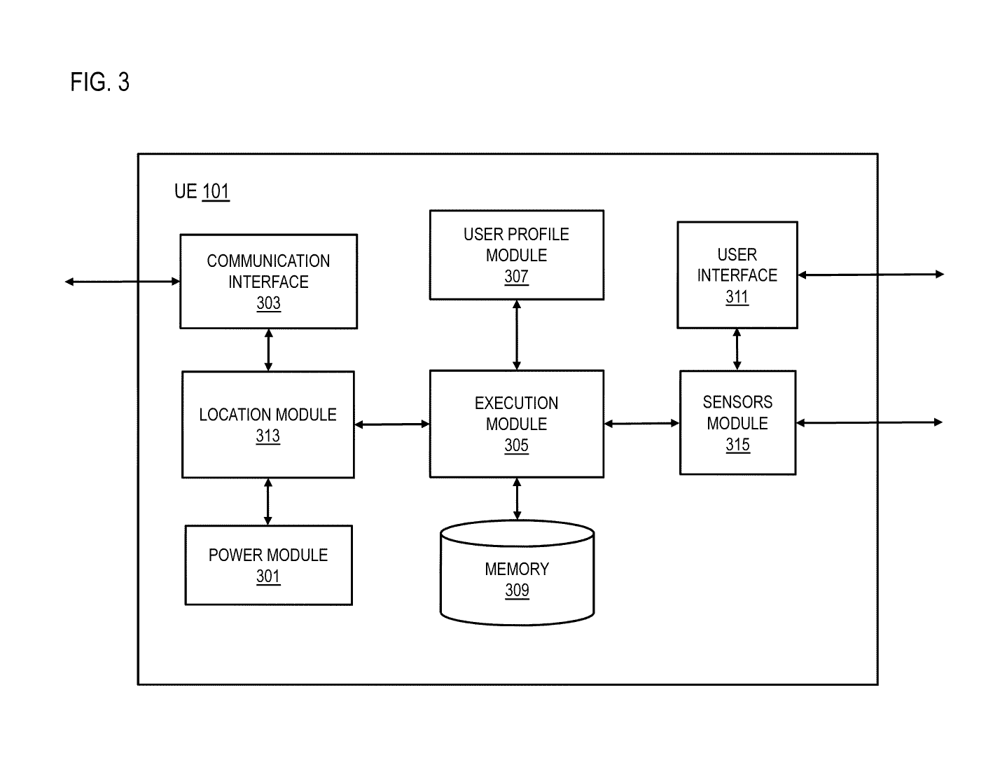

FIG. 3 is a diagram of the components of the UE 101, according to an embodiment. It is contemplated that the functions of these components may be combined in one or more components or performed by other components of equivalent functionality. In this embodiment, the UE 101 includes a power module 301 to provide power and power controls to the UE 101, a communication interface 303 to communicate over a network (e.g., the communication network 109), an execution module 305 to control the runtime of applications executing on the UE 101, a user profile module 307, a memory 309, a user interface 311, a location module 313 to determine location of the UE 101, and a sensors module 315 which may include, but is not limited to, a sound recorder, light sensor, global positioning system (GPS) and/or spatio-temporal detector, temperature sensor, motion sensor, accelerometer, gyroscope, camera and/or any other device for perceiving sensory and environmental phenomena.

In one embodiment, the UE 101 includes a power module 301. The power module 301 provides power to the UE 101. The power module 301 can include any type of power source (e.g., battery, plug-in, etc.). Additionally, the power module 301 can provide power to the components of the UE 101 including processors, memory 309, and transmitters.

The communication interface 303 may include multiple means of communication. For example, the communication interface 303 may be able to communicate over SMS, internet protocol, instant messaging, voice sessions (e.g., via a phone network), or other types of communication. The communication interface 303 can be used by the execution module 305 to communicate with other UE 101, the social networking services 105, the services platform 107, and other component of the communication network 109. In some examples, the communication interface 303 is used to transmit communication messages (e.g., social networking information) to other UE 101, the social networking services 105, the services platform 107, and/or to other components of the communication network 109.

In one embodiment, the user profile module 307 includes user preferences (e.g., interests in social networking topics, categories, geo-locations, events, etc.), user information (e.g., one or more social networking accounts), user base location, user device information (e.g., smartphone, capabilities, etc.), accessible services, and the like.

In one embodiment, a UE 101 includes a user interface 311, which may include various methods of communication. For example, the user interface 311 may have outputs including a visual component (e.g., a screen), an audio component, a physical component (e.g., vibrations), and/or other methods of communication. User inputs can include a touch-screen interface, a scroll-and-click interface, a button interface, etc. In certain embodiments, the user interface 311 may additionally have an audio user interface component. As such, a text-to-speech mechanism may be utilized to provide textual information to the user and/or a speech-to-text mechanism may be utilized to receive audio input and convert it into textual input. Moreover, the user interface 311 may be utilized to present one or more alerts (e.g., associated with social networking. It is noted that the user interface 311 also provides a means of display and interaction between the user and various executions and features of the social networking services 105, the services platform 107, and the processing platform 113 by way of a keyboard, virtual keypad, stylus, or other data input mechanism.

In one embodiment, the location module 313 can determine a UE 101 location (e.g., user's location). The UE 101 location can be determined by a triangulation system such as a global positioning system (GPS), assisted GPS (A-GPS), Cell of Origin, wireless local area network triangulation, or other location extrapolation technologies. Standard GPS and A-GPS systems can use satellites 115 to pinpoint the location (e.g., longitude, latitude, and altitude) of the UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The location module 313 may also utilize multiple technologies to detect the location of the UE 101. GPS coordinates can provide finer detail as to the location of the UE 101. As previously noted, the location module 313 may be utilized to determine location coordinates for use by the applications 103. In another embodiment, the UE 101 may utilize a local area network (e.g., WLAN) connection to determine the UE 101 location information, for example, from an Internet source (e.g., a service provider).

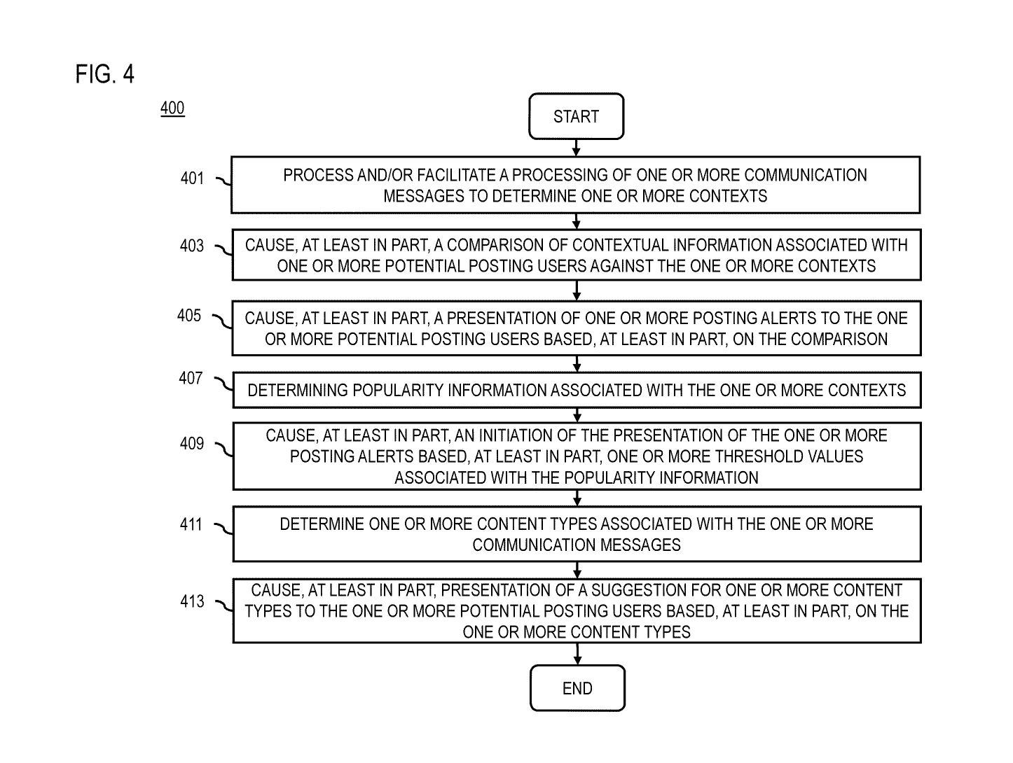

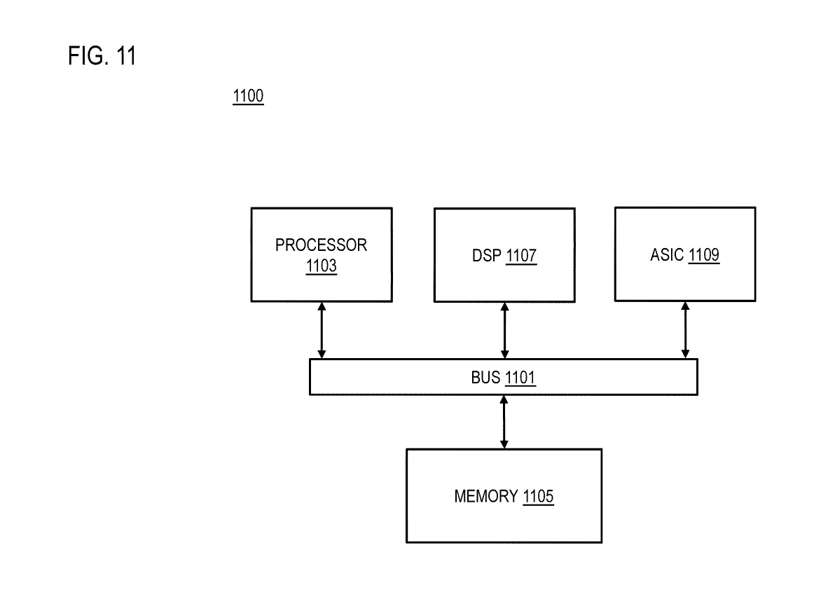

FIG. 4 is a flowchart of a process 400 for identifying and processing communication messages from one or more users to determine context and associated contextual information. Further, one or more posting alerts are determined and presented to potential posting users, according to one embodiment. In various embodiments, the processing platform 113 and/or the social networking services 105 perform all or parts of the process 400 and are implemented in, for instance, a chip set including a processor and a memory as shown FIG. 11. Moreover, the applications 103 may execute upon the execution module 305 for sharing communication messages and receiving the posting alerts.

In step 401, the processing platform 113 processes and/or facilitates a processing of one or more communication messages to determine one or more contexts. In one embodiment, a service provider (e.g., Nokia® Services) searches for and compiles one or more communication messages between one or more users and one or more services platforms (e.g., Facebook®, social networking sites, private and public blogging sites, etc.) and processes/analyzes the communication messages to determine associated context and contextual information (e.g., social networking information). For example, a communication message (e.g., a posting to a social networking site) from a user is sent to a social networking service provider, wherein the message includes contextual information about a topic, an event, a geo-location, and the like. In one embodiment, the service provider utilizes one or more algorithms, applications, software, and the like (e.g. web crawlers) to search for and analyze the one or more communication messages. In another embodiment, the one or more services platforms (e.g., Facebook®) utilize one or more algorithms, applications, software, and the like, to search for the communication messages at the one or more services platform (e.g., Facebook®) and further perform the analysis. In one embodiment, one or more service providers (e.g., Nokia®) and one or more services platforms (e.g., Facebook®) establish one or more mechanisms/agreements for conducting the search and analysis of the communication messages.

In step 403, the processing platform 113 causes, at least in part, a comparison of contextual information associated with one or more potential posting users against the one or more contexts. In one example, contextual information includes information about content of the communication message such as a topic, content type (e.g., text, video, audio, etc.), geo-location of a POI, geo-location of one or more users associated with the communication message, an event, and the like. In one use case scenario, the system 100 compares the contextual information with one or more potential users to determine one or more users who may be interested in providing/posting additional communication messages, social networking information, and the like. In one embodiment, determination of the one or more potential posting users are based, at least in part, on a user's geo-location, a user profile (e.g., age, gender, etc.), user preferences indicating interest in certain topics, content types, event types, certain geo-locations, POIs, and the like, wherein the user profile and/or the user preferences may be stored at the UE 101, the social networking services 105, the services platform 107, and/or at one or more other service providers.

In step 405, the processing platform 113 and causing, at least in part, a presentation of one or more posting alerts to the one or more potential posting users based, at least in part, on the comparison. In one embodiment, a service provider determines a potential posting user based on one or more matches identified in the comparison and presents one or more posting alerts to the potential user. For example, a posting alert is presented to a user who is in close proximity to an event (e.g., a rock concert) and/or the user preferences indicate that the user would be interested in posting about the event. In one embodiment, the one or more users associated with the one or more communication messages and/or the one or more potential posting users are either at the geo-location, in a close proximity to the geo-location, at a remote geo-location, or will arrive at the geo-location in the near future. For example, a user (e.g., a posting user) may send a communication message to a social networking site about an event at a certain geo-location, wherein the user currently is at a different geo-location (e.g., remote) than the event geo-location.

In another example, a potential posting user is at a remote location with reference to a potential posting alert associated with a certain geo-location.

In step 407, the processing platform 113 determines popularity information associated with the one or more contexts. In one example, the popularity information indicates frequency of access and/or referral to the one or more contexts of the communication messages (e.g., postings). For example, a context may be referred to in multiple communication messages (e.g., postings), by multiple users, and/or at multiple service platforms (e.g., social networking sites). In another embodiment, one or more communication messages (e.g., blogs, postings) may have high popularity due to higher access and/or referral by other users.

In step 409, the processing platform 113 causes, at least in part, an initiation of the presentation of the one or more posting alerts based, at least in part, one or more threshold values associated with the popularity information. In one use case scenario, the popularity information can trigger the presentation of the one or more posting alerts to one or more users. For example, popularity information associated with a certain context may match a threshold value set in a user profile and/or preference, which can cause the presentation of the posting alert. In one embodiment the one or more threshold values are based, at least in part, on one or more parameters associated with the one or more contexts, one or more user preferences, a ranking, a rating, a category, a content type, a geo-location, a topic, identity of a posting user, time of the posting, or a combination thereof.

In one embodiment the presentation of the one or more posting alerts is via a map application, a texting application, a multimedia application, or a combination thereof. In one example, the posting alert is presented as a list including one or more items providing one or more information items (e.g., geo-location, context, event information, posted content types, suggested content types to post, etc.) associated with one or more posting opportunities. In another example, the posting alerts are presented on a map application, whereby a user may utilize a user interface to interact with the map application indicating the user location and/or location of the potential posting alerts (e.g., events) presented thereon. It is noted that the user interface 311 provides a means of interaction between the users and the various executions and features of the processing platform 113 and social networking services 105 by way of a keyboard, virtual keypad, stylus, or other data input mechanism. Any capabilities afforded by the particular social networking services 105 may be rendered to the display of UE 101 by way of the user interface 311.

In step 411, the processing platform 113 determines one or more content types associated with the one or more communication messages. In one example, the one or more communication messages may include one or more contents of different types such as textual, audio, video, photos, and the like. In various embodiments, the system 100 may utilize one or more applications and/or algorithms to determine the content type, wherein the content types may not be explicitly indicated (e.g., a photo file without any further comments/contextual information).

In step 413, the processing platform 113 causes, at least in part, presentation of a suggestion for one or more content types to the one or more potential posting users based, at least in part, on the one or more content types. In one embodiment, based on the determined content types associated with the one or more communication messages, the system 100 may further determine one or more over-represented and/or under-represented content types (e.g., textual, multimedia, etc.) and accordingly provide one or more suggestions to the potential posting users as to what content types to include with their postings. For example, a musical concert may trigger many users to take pictures of the concert stage and upload/share them via one or more social networking sites (e.g., Facebook®, Twitter®, etc.). However, online audience remotely following the concert through the social networking posts may be particularly interested in additional textual posts as it could provide additional perspectives and points for people to follow and potentially provide additional input/comments.

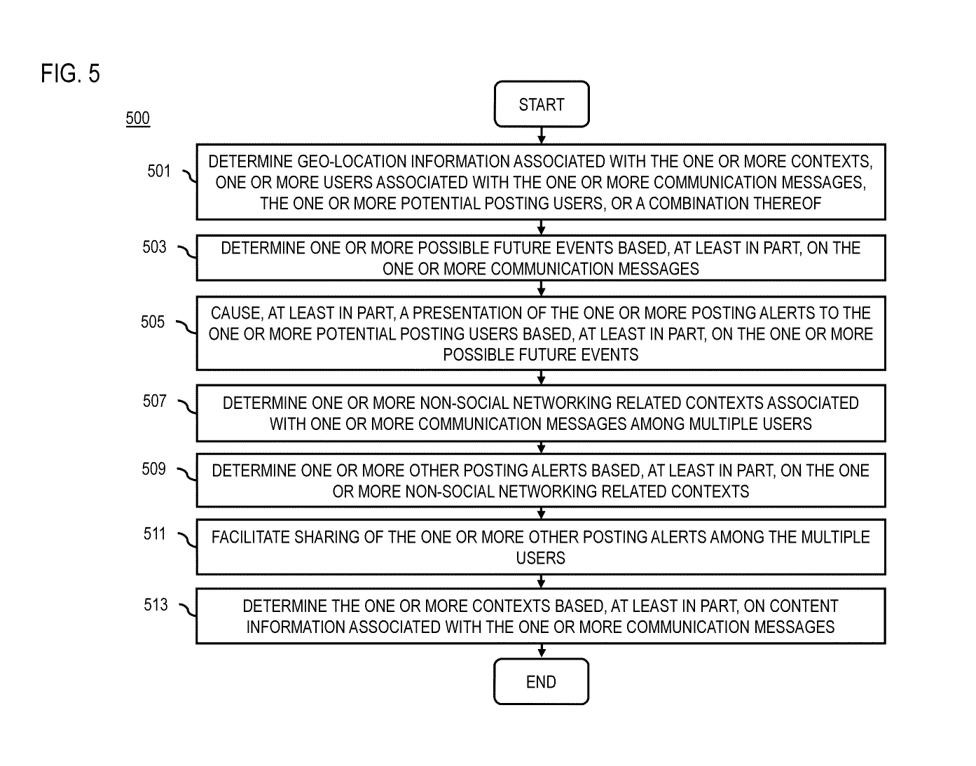

FIG. 5 is a flowchart of a process 500 for determining geo-location information and one or more possible future events associated with the one or more contexts and/or one or more users, according to one embodiment. In various embodiments, the processing platform 113 and/or the social networking services 105 perform all or parts of the process 500 and are implemented in, for instance, a chip set including a processor and a memory as shown FIG. 11. Moreover, the applications 103 may execute upon the execution module 305 for sharing location information.

In step 501, the processing platform 113 determines geo-location information associated with the one or more contexts, one or more users associated with the one or more communication messages, the one or more potential posting users, or a combination thereof. In various embodiments, the system 100 may utilize information, metadata, content, and the like associated with the one or more contexts to determine a geo-location associated with the context and/or a user providing a communication message. For example, the system 100 may utilize a photo (e.g., Eifel Tower) included in a communication message to determine a substantially accurate geo-location (e.g., Paris). In another example, a geo-location may be determined by GPS location information associated with a user device, metadata associated with a multimedia item, and the like. In another embodiment, a user may manually enter/provide/submit a geo-location of the user and/or of an event via the UE 101.

In step 503, the processing platform 113 determines one or more possible future events based, at least in part, on the one or more communication messages. In one embodiment, system 100 analyzes contextual information included in metadata of a communication message (e.g., uploaded posts) and/or multimedia content items associated with a posting opportunity areas in order to determine contextual factors which may assist in predicting emergence of early signs of potential posting opportunity areas (e.g., hot spots). For example, in a case of a musical concert in a given stadium, the analysis may indicate/suggest that a musical concert typically is preceded by increased traffic around the stadium. Hence in the future, upon detecting such early signs of emergence of posting opportunity hot spots, users may be provided with tips about the onset of such events in the near future.

In step 505, the processing platform 113 causes, at least in part, a presentation of the one or more posting alerts to the one or more potential posting users based, at least in part, on the one or more possible future events. In one example, upon detecting early signs of a potential posting opportunity area, the system 100 may present posting alerts to potential users about possible events in the near future, wherein the early posting alerts may be useful for users who wish to be the first ones to start posting about an interesting event, topic, and the like and to quickly gather followers (e.g., other users, service providers, bloggers, etc.)

In step 507, the processing platform 113 determines one or more non-social networking related contexts associated with or more communication messages among multiple users. In one example, multiple users may exchange one or more communication messages (e.g., including social networking information) with each other via a communication network (e.g., cellular network, WLAN, etc.) before and/or without posting the messages to a social networking site/service, wherein the system 100 may analyze these communication messages in order to determine possible contextual information associated with a potential posting opportunity (e.g., an event, a geo-location, a topic, etc.)

In step 509, the processing platform 113 determines one or more other posting alerts based, at least in part, on the one or more non-social networking related contexts and in step 511, the processing platform 113 facilitates sharing of the one or more other posting alerts among the multiple users.

In step 513, the processing platform 113 determining the one or more contexts based, at least in part, on content information associated with the one or more communication messages.

In one embodiment, textual content of the communication messages (e.g., SMS, text comments) and/or one or more text strings may be analyzed to determine POIs (e.g. “Big Ben Bar,” “City Square,” “City College,” etc.) as well as geo-located activities (e.g. word “riot,” “speech,” “party,” etc.). In another embodiment, multimedia content included in the communication message may be analyzed by one or more image recognition processes to recognize geo-located reference points featuring one or more images included in the multimedia content. For example, when geo-located objects/landmarks (e.g., buildings, parks, statues, etc.) are recognized, they are compared against one or more POI databases in order to determine the actual object/landmark. For instance, if an image recognition process results in identification of an apartment building (e.g., determined to be situated north-west of the posting user's present location) then the actual apartment building is identified using the POI database. In addition to geo-located objects, the image recognition process may also indicate geo-located activities such as a social behavior (e.g., presence of a crowd of people).

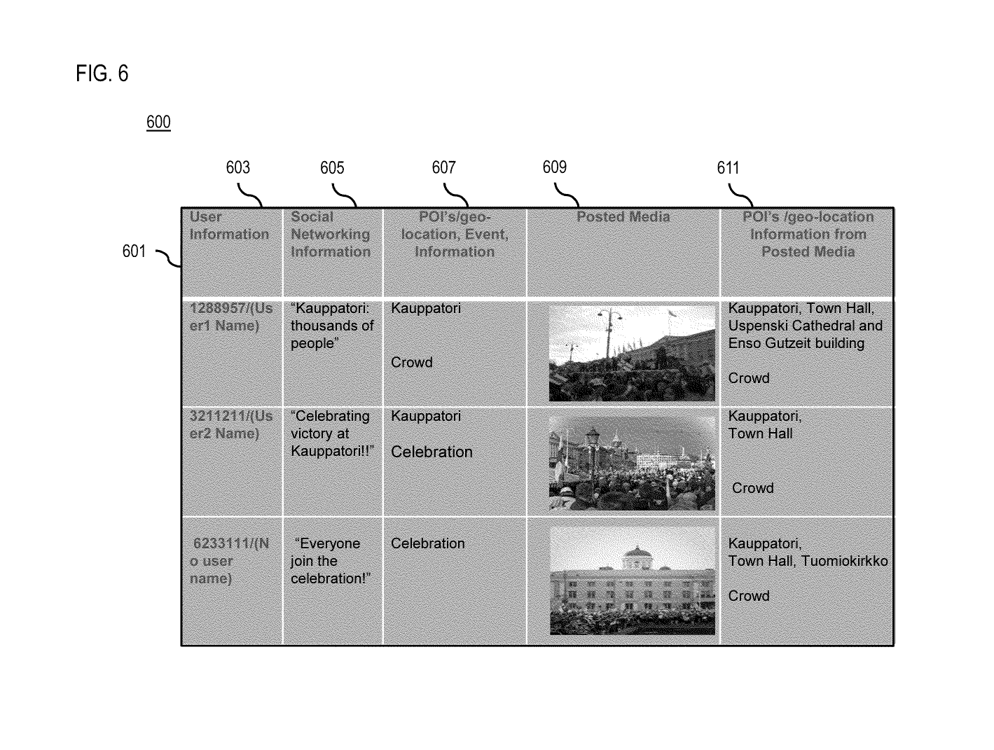

FIG. 6 shows table 600 illustrating contextual information and content determined from one or more communication messages, according to an embodiment. In one example, communication messages 601 in the table 600 (e.g., from a hot spot) and the identified geo-located POIs are analyzed to determine frequently occurring reference points. For instance, the communication messages 601 are posted/uploaded by three users from an area in Helsinki within a few minutes of each other and their analysis indicates potential emergence of a posting hot spot. In one example, the communication messages 601 includes user information 603 (e.g., ID, name, social networking name, etc.), social networking information 605, POIs/geo-location information 607, posted media 609, and POIs/geo-location information 611 determined from the posted media. It is noted that one or more analysis are done in order to find the most frequently occurring references to one or more POIs, event, topics, categories, and the like. In one embodiment, the user information 603 may be provided by the user or may be determined by one or more other parameters included in the communication message, for example, a device ID number, a phone number, an account number, and the like. In one embodiment, the social networking information 605 may include textual information indicating a POI, an event description, a topic, a category, and the like. In one embodiment, one or more information associated with the social networking information 607 such as POI/geo-location (e.g., “Kauppatori”) and event information (e.g., crowd), and the like may be determined from the social networking information 605 in order to provide clear indications to a user on where, what, when, how, and the like. In one embodiment, one or more media items 609 (e.g., audio, video, photos, etc.) is included in the communication message, which can provide further information on the POI/geo-location to a user. In one embodiment, the system 100 can utilize posted media 609 in order to determine (e.g., from the communication message information, from the internet, etc.) information 611 associated with the media (e.g., identify the POI and note if there is a large group of people at the POI.) Considering the POIs identified from the content displayed in the table 600, the most frequently occurring POI in the textual content of the three service users is ‘Kauppatori’ (a location in the harbor area of Helsinki) and ‘celebration’ is the most frequently occurring term pertaining to the geo-located activity. Further, analysis of the media items 609 indicates most frequently occurring POI's “Kauppatori” and “Town Hall.” Furthermore, the geo-located activity “crowd” is most frequently mentioned. In one embodiment, the frequently occurring POIs are utilized to provide alerts of potential posting opportunities to users near the POIs. For example, considering analysis of the communication messages 601 (e.g., postings) a posting opportunity alert may be presented to users near the POI geo-location as “Posts related to a celebration taking place in your proximity are currently attracting plenty of attention at a social networking site (e.g., Facebook®). Please look for a crowd around Kauppatori and Town Hall in order to report/post about the activity, too.”

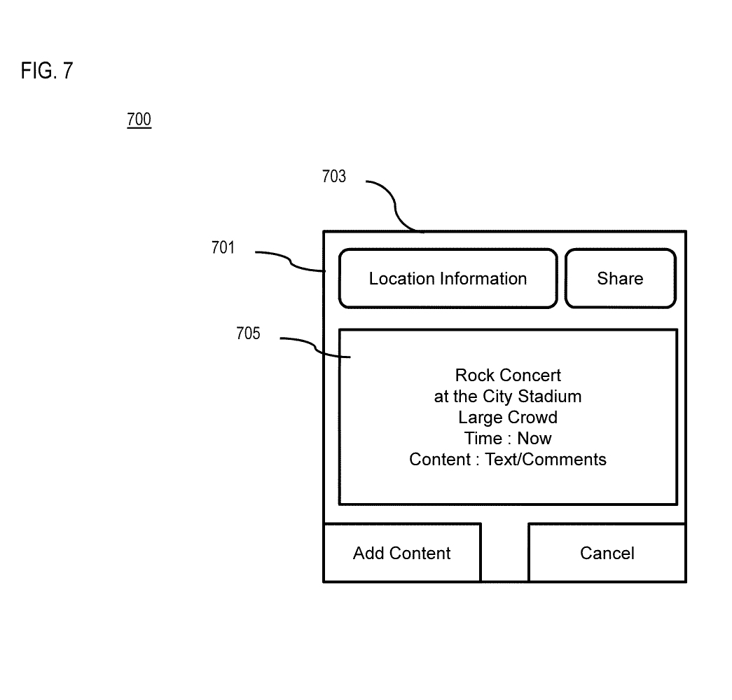

FIG. 7 illustrates a textual communication message 700 by a user associated with an event at a geo-location, according to one embodiment. In use case scenario, system 100 may analyze the text message 701 (e.g., SMS) to determine one more contextual information such as location information 703 identified by a user and/or determined by the system 100 (e.g., GPS location) and additional information items included in 705. Further, the information items 705 may provide further information about the event such as a type of event (e.g., a rock concert), a location (e.g., city stadium), size of people gathering (e.g., large crowd), time (e.g. now), and one or more contents included in the communication message (e.g., text, comments, etc.). In one embodiment, potential posting users may be close to the identified geo-location or may be at a remote geo-location, but still interested in the topic/event.

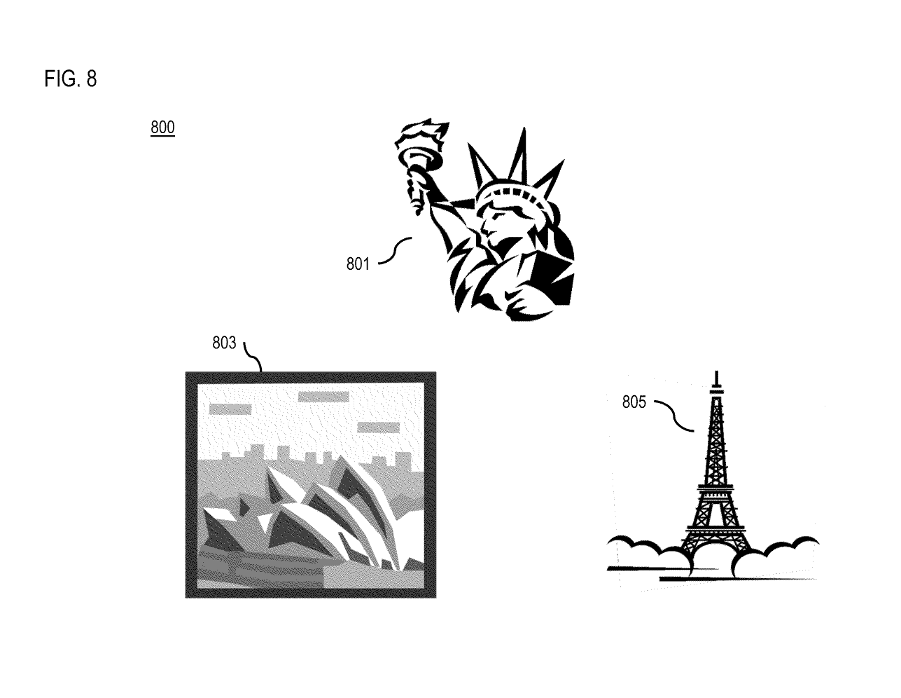

FIG. 8 illustrates graphical content 800 indicating various points of interest associated with one or more communication messages, according to one embodiment. In one embodiment, the system 100 may receive/find various communication messages which may include media items (e.g., video, photos, etc.) with little or no other associated information. For example, the communication messages may contain references to media 801 (e.g., Statue of Liberty, USA), 803 (e.g., Sydney Opera House), or 805 (e.g., Eifel Tower, Paris), which may assist in identifying a current or a soon to be hot spot for online posting.

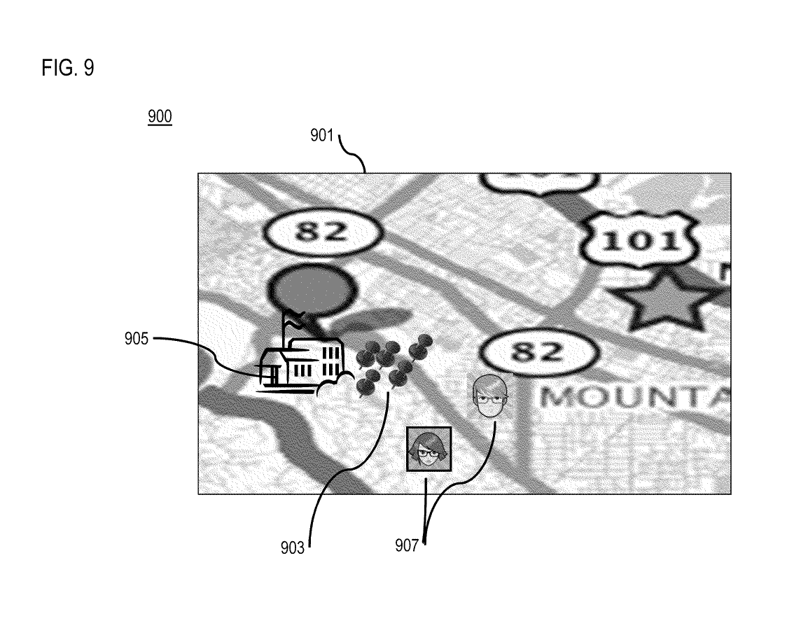

FIG. 9 illustrates presentation 900 of location information of one or more communication messages on a map application, according to one embodiment. In one example, a map application 901 may be utilized to present location information of one or more communication messages (e.g., social networking posting hot spot) 903 and an associated POI 905 (e.g., a college campus). Further, geo-locations of one or more potential posting users 907 (e.g., user1, user2, etc.) may also be indicated on the map application 901 so that the potential posting users may have a reference point and utilize the map application for determining a travel route to the event's geo-location 905.

The processes described herein for identifying and processing one or more communication messages (e.g., social networking postings) and alerting potential posting users for submitting additional postings may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

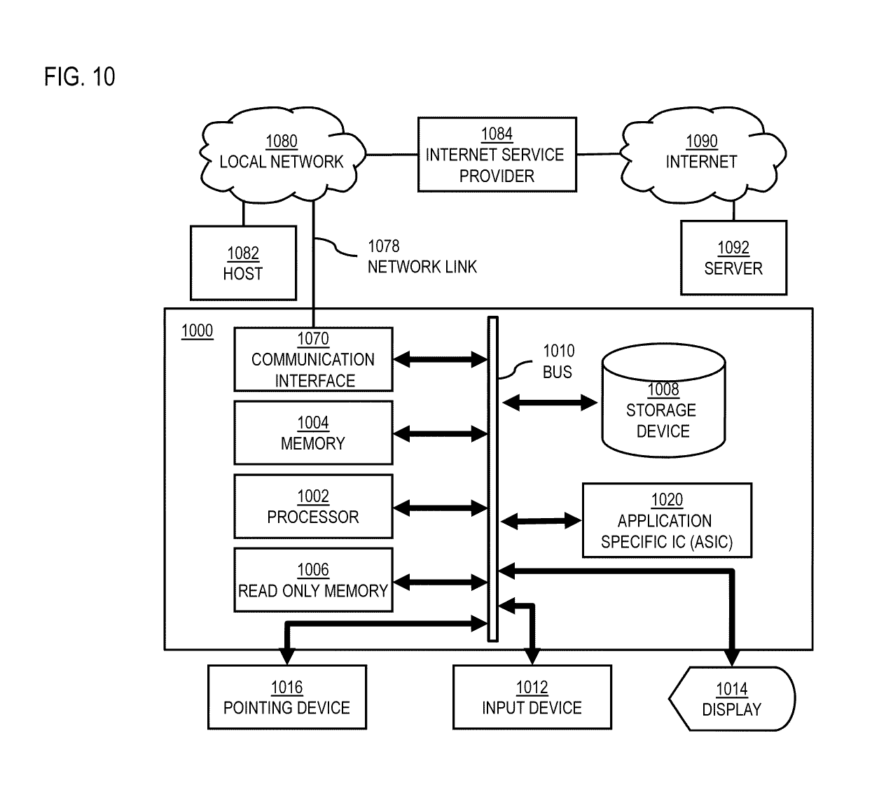

FIG. 10 illustrates a computer system 1000 upon which an embodiment of the invention may be implemented. Although computer system 1000 is depicted with respect to a particular device or equipment, it is contemplated that other devices or equipment (e.g., network elements, servers, etc.) within FIG. 10 can deploy the illustrated hardware and components of system 1000. Computer system 1000 is programmed (e.g., via computer program code or instructions) to identify and process one or more communication messages (e.g., social networking postings) and alert potential posting users for submitting additional postings as described herein and includes a communication mechanism such as a bus 1010 for passing information between other internal and external components of the computer system 1000. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1000 or a portion thereof, constitutes a means for identifying and processing one or more communication messages (e.g., social networking postings) and alerting potential posting users for submitting additional postings.

A bus 1010 includes one or more parallel conductors of information so that information is transferred quickly among devices coupled to the bus 1010. One or more processors 1002 for processing information are coupled with the bus 1010.

A processor (or multiple processors) 1002 performs a set of operations on information as specified by computer program code related to identifying and processing one or more communication messages (e.g., social networking postings) and alerting potential posting users for submitting additional postings. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1010 and placing information on the bus 1010. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1002, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1000 also includes a memory 1004 coupled to bus 1010. The memory 1004, such as a random access memory (RAM) or any other dynamic storage device, stores information including processor instructions for identifying and processing one or more communication messages (e.g., social networking postings) and alerting potential posting users for submitting additional postings. Dynamic memory allows information stored therein to be changed by the computer system 1000. RAM allows a unit of information stored at a location called a memory address to be stored and retrieved independently of information at neighboring addresses. The memory 1004 is also used by the processor 1002 to store temporary values during execution of processor instructions. The computer system 1000 also includes a read only memory (ROM) 1006 or any other static storage device coupled to the bus 1010 for storing static information, including instructions, that is not changed by the computer system 1000. Some memory is composed of volatile storage that loses the information stored thereon when power is lost. Also coupled to bus 1010 is a non-volatile (persistent) storage device 1008, such as a magnetic disk, optical disk or flash card, for storing information, including instructions, that persists even when the computer system 1000 is turned off or otherwise loses power.

Information, including instructions for identifying and processing one or more communication messages (e.g., social networking postings) and alerting potential posting users for submitting additional postings, is provided to the bus 1010 for use by the processor from an external input device 1012, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 1000. Other external devices coupled to bus 1010, used primarily for interacting with humans, include a display device 1014, such as a cathode ray tube (CRT), a liquid crystal display (LCD), a light emitting diode (LED) display, an organic LED (OLED) display, a plasma screen, or a printer for presenting text or images, and a pointing device 1016, such as a mouse, a trackball, cursor direction keys, or a motion sensor, for controlling a position of a small cursor image presented on the display 1014 and issuing commands associated with graphical elements presented on the display 1014. In some embodiments, for example, in embodiments in which the computer system 1000 performs all functions automatically without human input, one or more of external input device 1012, display device 1014 and pointing device 1016 is omitted.

In the illustrated embodiment, special purpose hardware, such as an application specific integrated circuit (ASIC) 1020, is coupled to bus 1010. The special purpose hardware is configured to perform operations not performed by processor 1002 quickly enough for special purposes. Examples of ASICs include graphics accelerator cards for generating images for display 1014, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1000 also includes one or more instances of a communications interface 1070 coupled to bus 1010. Communication interface 1070 provides a one-way or two-way communication coupling to a variety of external devices that operate with their own processors, such as printers, scanners and external disks. In general the coupling is with a network link 1078 that is connected to a local network 1080 to which a variety of external devices with their own processors are connected. For example, communication interface 1070 may be a parallel port or a serial port or a universal serial bus (USB) port on a personal computer. In some embodiments, communications interface 1070 is an integrated services digital network (ISDN) card or a digital subscriber line (DSL) card or a telephone modem that provides an information communication connection to a corresponding type of telephone line. In some embodiments, a communication interface 1070 is a cable modem that converts signals on bus 1010 into signals for a communication connection over a coaxial cable or into optical signals for a communication connection over a fiber optic cable. As another example, communications interface 1070 may be a local area network (LAN) card to provide a data communication connection to a compatible LAN, such as Ethernet. Wireless links may also be implemented. For wireless links, the communications interface 1070 sends or receives or both sends and receives electrical, acoustic or electromagnetic signals, including infrared and optical signals that carry information streams, such as digital data. For example, in wireless handheld devices, such as mobile telephones like cell phones, the communications interface 1070 includes a radio band electromagnetic transmitter and receiver called a radio transceiver. In certain embodiments, the communications interface 1070 enables connection to the communication network 109 for identifying and processing one or more communication messages (e.g., social networking postings) and alerting potential posting users for submitting additional postings.

The term “computer-readable medium” as used herein refers to any medium that participates in providing information to processor 1002, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1008. Volatile media include, for example, dynamic memory 1004. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1020.

Network link 1078 typically provides information communication using transmission media through one or more networks to other devices that use or process the information. For example, network link 1078 may provide a connection through local network 1080 to a host computer 1082 or to equipment 1084 operated by an Internet Service Provider (ISP). ISP equipment 1084 in turn provides data communication services through the public, world-wide packet-switching communication network of networks now commonly referred to as the Internet 1090.

A computer called a server host 1092 connected to the Internet hosts a process that provides a service in response to information received over the Internet. For example, server host 1092 hosts a process that provides information representing video data for presentation at display 1014. It is contemplated that the components of system 1000 can be deployed in various configurations within other computer systems, e.g., host 1082 and server 1092.

At least some embodiments of the invention are related to the use of computer system 1000 for implementing some or all of the techniques described herein. According to one embodiment of the invention, those techniques are performed by computer system 1000 in response to processor 1002 executing one or more sequences of one or more processor instructions contained in memory 1004. Such instructions, also called computer instructions, software and program code, may be read into memory 1004 from another computer-readable medium such as storage device 1008 or network link 1078. Execution of the sequences of instructions contained in memory 1004 causes processor 1002 to perform one or more of the method steps described herein. In alternative embodiments, hardware, such as ASIC 1020, may be used in place of or in combination with software to implement the invention. Thus, embodiments of the invention are not limited to any specific combination of hardware and software, unless otherwise explicitly stated herein.

The signals transmitted over network link 1078 and other networks through communications interface 1070, carry information to and from computer system 1000. Computer system 1000 can send and receive information, including program code, through the networks 1080, 1090 among others, through network link 1078 and communications interface 1070. In an example using the Internet 1090, a server host 1092 transmits program code for a particular application, requested by a message sent from computer 1000, through Internet 1090, ISP equipment 1084, local network 1080 and communications interface 1070. The received code may be executed by processor 1002 as it is received, or may be stored in memory 1004 or in storage device 1008 or any other non-volatile storage for later execution, or both. In this manner, computer system 1000 may obtain application program code in the form of signals on a carrier wave.

Various forms of computer readable media may be involved in carrying one or more sequence of instructions or data or both to processor 1002 for execution. For example, instructions and data may initially be carried on a magnetic disk of a remote computer such as host 1082. The remote computer loads the instructions and data into its dynamic memory and sends the instructions and data over a telephone line using a modem. A modem local to the computer system 1000 receives the instructions and data on a telephone line and uses an infra-red transmitter to convert the instructions and data to a signal on an infra-red carrier wave serving as the network link 1078. An infrared detector serving as communications interface 1070 receives the instructions and data carried in the infrared signal and places information representing the instructions and data onto bus 1010. Bus 1010 carries the information to memory 1004 from which processor 1002 retrieves and executes the instructions using some of the data sent with the instructions. The instructions and data received in memory 1004 may optionally be stored on storage device 1008, either before or after execution by the processor 1002.

FIG. 11 illustrates a chip set or chip 1100 upon which an embodiment of the invention may be implemented. Chip set 1100 is programmed to identify and process one or more communication messages (e.g., social networking postings) and alert potential posting users for submitting additional postings as described herein and includes, for instance, the processor and memory components described with respect to FIG. 10 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1100 can be implemented in a single chip. It is further contemplated that in certain embodiments the chip set or chip 1100 can be implemented as a single “system on a chip.” It is further contemplated that in certain embodiments a separate ASIC would not be used, for example, and that all relevant functions as disclosed herein would be performed by a processor or processors. Chip set or chip 1100, or a portion thereof, constitutes a means for performing one or more steps of providing user interface navigation information associated with the availability of functions. Chip set or chip 1100, or a portion thereof, constitutes a means for performing one or more steps of identifying and processing one or more communication messages (e.g., social networking postings) and alerting potential posting users for submitting additional postings.

In one embodiment, the chip set or chip 1100 includes a communication mechanism such as a bus 1101 for passing information among the components of the chip set 1100. A processor 1103 has connectivity to the bus 1101 to execute instructions and process information stored in, for example, a memory 1105. The processor 1103 may include one or more processing cores with each core configured to perform independently. A multi-core processor enables multiprocessing within a single physical package. Examples of a multi-core processor include two, four, eight, or greater numbers of processing cores. Alternatively or in addition, the processor 1103 may include one or more microprocessors configured in tandem via the bus 1101 to enable independent execution of instructions, pipelining, and multithreading. The processor 1103 may also be accompanied with one or more specialized components to perform certain processing functions and tasks such as one or more digital signal processors (DSP) 1107, or one or more application-specific integrated circuits (ASIC) 1109. A DSP 1107 typically is configured to process real-world signals (e.g., sound) in real time independently of the processor 1103. Similarly, an ASIC 1109 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1100 includes merely one or more processors and some software and/or firmware supporting and/or relating to and/or for the one or more processors.

The processor 1103 and accompanying components have connectivity to the memory 1105 via the bus 1101. The memory 1105 includes both dynamic memory (e.g., RAM, magnetic disk, writable optical disk, etc.) and static memory (e.g., ROM, CD-ROM, etc.) for storing executable instructions that when executed perform the inventive steps described herein to identify and process one or more communication messages (e.g., social networking postings) and alert potential posting users for submitting additional postings. The memory 1105 also stores the data associated with or generated by the execution of the inventive steps.

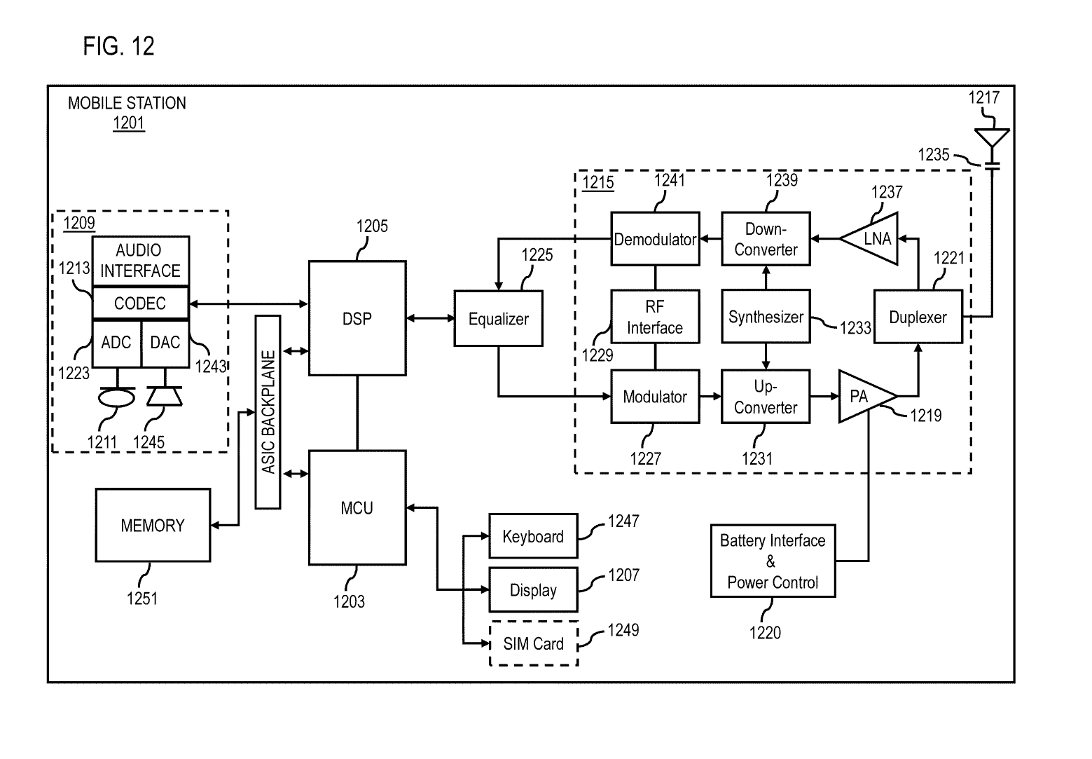

FIG. 12 is a diagram of exemplary components of a mobile terminal (e.g., handset) for communications, which is capable of operating in the system of FIG. 1, according to one embodiment. In some embodiments, mobile terminal 1201, or a portion thereof, constitutes a means for performing one or more steps of identifying and processing one or more communication messages (e.g., social networking postings) and alerting potential posting users for submitting additional postings. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1203, a Digital Signal Processor (DSP) 1205, and a receiver/transmitter unit including a microphone gain control unit and a speaker gain control unit. A main display unit 1207 provides a display to the user in support of various applications and mobile terminal functions that perform or support the steps of identifying and processing one or more communication messages (e.g., social networking postings) and alerting potential posting users for submitting additional postings. The display 1207 includes display circuitry configured to display at least a portion of a user interface of the mobile terminal (e.g., mobile telephone). Additionally, the display 1207 and display circuitry are configured to facilitate user control of at least some functions of the mobile terminal. An audio function circuitry 1209 includes a microphone 1211 and microphone amplifier that amplifies the speech signal output from the microphone 1211. The amplified speech signal output from the microphone 1211 is fed to a coder/decoder (CODEC) 1213.

A radio section 1215 amplifies power and converts frequency in order to communicate with a base station, which is included in a mobile communication system, via antenna 1217. The power amplifier (PA) 1219 and the transmitter/modulation circuitry are operationally responsive to the MCU 1203, with an output from the PA 1219 coupled to the duplexer 1221 or circulator or antenna switch, as known in the art. The PA 1219 also couples to a battery interface and power control unit 1220.

In use, a user of mobile terminal 1201 speaks into the microphone 1211 and his or her voice along with any detected background noise is converted into an analog voltage. The analog voltage is then converted into a digital signal through the Analog to Digital Converter (ADC) 1223. The control unit 1203 routes the digital signal into the DSP 1205 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1225 for compensation of any frequency-dependent impairments that occur during transmission though the air such as phase and amplitude distortion. After equalizing the bit stream, the modulator 1227 combines the signal with a RF signal generated in the RF interface 1229. The modulator 1227 generates a sine wave by way of frequency or phase modulation. In order to prepare the signal for transmission, an up-converter 1231 combines the sine wave output from the modulator 1227 with another sine wave generated by a synthesizer 1233 to achieve the desired frequency of transmission. The signal is then sent through a PA 1219 to increase the signal to an appropriate power level. In practical systems, the PA 1219 acts as a variable gain amplifier whose gain is controlled by the DSP 1205 from information received from a network base station. The signal is then filtered within the duplexer 1221 and optionally sent to an antenna coupler 1235 to match impedances to provide maximum power transfer. Finally, the signal is transmitted via antenna 1217 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1201 are received via antenna 1217 and immediately amplified by a low noise amplifier (LNA) 1237. A down-converter 1239 lowers the carrier frequency while the demodulator 1241 strips away the RF leaving only a digital bit stream. The signal then goes through the equalizer 1225 and is processed by the DSP 1205. A Digital to Analog Converter (DAC) 1243 converts the signal and the resulting output is transmitted to the user through the speaker 1245, all under control of a Main Control Unit (MCU) 1203 which can be implemented as a Central Processing Unit (CPU).

The MCU 1203 receives various signals including input signals from the keyboard 1247. The keyboard 1247 and/or the MCU 1203 in combination with other user input components (e.g., the microphone 1211) comprise a user interface circuitry for managing user input. The MCU 1203 runs a user interface software to facilitate user control of at least some functions of the mobile terminal 1201 for identifying and processing one or more communication messages (e.g., social networking postings) and alerting potential posting users for submitting additional postings. The MCU 1203 also delivers a display command and a switch command to the display 1207 and to the speech output switching controller, respectively. Further, the MCU 1203 exchanges information with the DSP 1205 and can access an optionally incorporated SIM card 1249 and a memory 1251. In addition, the MCU 1203 executes various control functions required of the terminal. The DSP 1205 may, depending upon the implementation, perform any of a variety of conventional digital processing functions on the voice signals. Additionally, DSP 1205 determines the background noise level of the local environment from the signals detected by microphone 1211 and sets the gain of microphone 1211 to a level selected to compensate for the natural tendency of the user of the mobile terminal 1201.

The CODEC 1213 includes the ADC 1223 and DAC 1243. The memory 1251 stores various data including call incoming tone data and is capable of storing other data including music data received via, e.g., the global Internet. The software module could reside in RAM memory, flash memory, registers, or any other form of writable storage medium known in the art. The memory device 1251 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1249 carries, for instance, important information, such as the cellular phone number, the carrier supplying service, subscription details, and security information. The SIM card 1249 serves primarily to identify the mobile terminal 1201 on a radio network. The card 1249 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
a processing of one or more communication messages to determine one or more contexts;
a comparison of contextual information associated with one or more potential posting users against the one or more contexts; and
a presentation of one or more posting alerts to the one or more potential posting users based, at least in part, on the comparison.

2. A method of claim 1, wherein the (1) data and/or (2) information and/or (3) at least one signal are further based, at least in part, on the following:
at least one determination of popularity information associated with the one or more contexts; and
an initiation of the presentation of the one or more posting alerts based, at least in part, one or more threshold values associated with the popularity information.

3. A method of claim 1, wherein the (1) data and/or (2) information and/or (3) at least one signal are further based, at least in part, on the following:
at least one determination of one or more content types associated with the one or more communication messages; and
a presentation of a suggestion for one or more content types to the one or more potential posting users based, at least in part, on the determined one or more content types.

4. A method of claim 1, wherein the (1) data and/or (2) information and/or (3) at least one signal are further based, at least in part, on the following:
at least one determination of geo-location information associated with the one or more contexts, one or more users associated with the one or more communication messages, the one or more potential posting users, or a combination thereof.

5. A method of claim 1, wherein one or more users associated with the one or more communication messages and/or the one or more potential posting users are at the geo-location, in a close proximity to the geo-location, at a remote geo-location, or will arrive at the geo-location in the near future.

6. A method of claim 1, wherein the (1) data and/or (2) information and/or (3) at least one signal are further based, at least in part, on the following:
at least one determination one or more possible future events based, at least in part, on the one or more communication messages; and
a presentation of the one or more posting alerts to the one or more potential posting users based, at least in part, on the one or more possible future events.

7. A method of claim 2, wherein the one or more threshold values are based, at least in part, on one or more parameters associated with the one or more contexts, one or more user preferences, a ranking, a rating, a category, a content type, a geo-location, a topic, identity of a posting user, time of the posting, or a combination thereof.

8. A method of claim 2, wherein the presentation of the one or more posting alerts is via a map application, a texting application, a multimedia application, or a combination thereof.

9. A method of claim 1, wherein the (1) data and/or (2) information and/or (3) at least one signal are further based, at least in part, on the following and wherein the one or more communication messages are among multiple users:
at least one determination of one or more non-social networking related contexts;
at least one determination of one or more other posting alerts based, at least in part, on the one or more non-social networking contexts; and
a facilitation of sharing of the one or more other posting alerts among the multiple users.

10. A method of claim 1, wherein the (1) data and/or (2) information and/or (3) at least one signal are further based, at least in part, on the following:
at least one determination of the one or more contexts based, at least in part, on content information associated with the one or more communication messages.

11. An apparatus comprising:
at least one processor; and
at least one memory including computer program code for one or more programs,
the at least one memory and the computer program code configured to, with the at least one processor, cause the apparatus to perform at least the following,
process and/or facilitate a processing of one or more communication messages to determine one or more contexts;
cause, at least in part, a comparison of contextual information associated with one or more potential posting users against the one or more contexts; and
cause, at least in part, a presentation of one or more posting alerts to the one or more potential posting users based, at least in part, on the comparison.

12. An apparatus of claim 11, wherein the apparatus is further caused to:
determine popularity information associated with the one or more contexts; and
cause, at least in part, an initiation of the presentation of the one or more posting alerts based, at least in part, one or more threshold values associated with the popularity information.

13. An apparatus of claim 11, wherein the apparatus is further caused to:
determine one or more content types associated with the one or more communication messages; and
cause, at least in part, a presentation of a suggestion for one or more content types to the one or more potential posting users based, at least in part, on the determined one or more content types.

14. An apparatus of claim 11, wherein the apparatus is further caused to:
determine geo-location information associated with the one or more contexts, one or more users associated with the one or more communication messages, the one or more potential posting users, or a combination thereof.

15. An apparatus of claim 11, wherein one or more users associated with the one or more communication messages and/or the one or more potential posting users are at the geo-location, in a close proximity to the geo-location, at a remote geo-location, or will arrive at the geo-location in the near future.

16. An apparatus of claim 11, wherein the apparatus is further caused to:
determine one or more possible future events based, at least in part, on the one or more communication messages; and
cause, at least in part, a presentation of the one or more posting alerts to the one or more potential posting users based, at least in part, on the one or more possible future events.

17. An apparatus of claim 12, wherein the one or more threshold values are based, at least in part, on one or more parameters associated with the one or more contexts, one or more user preferences, a ranking, a rating, a category, a content type, a geo-location, a topic, identity of a posting user, time of the posting, or a combination thereof.

18. An apparatus of claim 12, wherein the presentation of the one or more posting alerts is via a map application, a texting application, a multimedia application, or a combination thereof.

19. An apparatus of claim 11, wherein the one or more communication messages are among multiple users, the apparatus further caused to:
determine one or more non-social networking related contexts;
determine one or more other posting alerts based, at least in part, on the one or more non-social networking contexts; and
facilitate sharing of the one or more other posting alerts among the multiple users.

20. An apparatus of claim 11, wherein the apparatus is further caused to:
determine the one or more contexts based, at least in part, on content information associated with the one or more communication messages.

21-48. (canceled)
